(19) United States
(12) Patent Application Publication
(10) Pub. No.: US 2008/0136830 A1
(43) Pub. Date: Jun. 12, 2008

(54) LOGO DISPLAY METHOD AND APPARATUS OF MULTIMEDIA PLAYER

(75) Inventor: Pil- seung YANG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/743,827

(22) Filed: May 3, 2007

(30) Foreign Application Priority Data
Dec. 7, 2006 (KR) 10-2006-0124046

(51) Int. Cl. G09G 5/39

(52) U.S. Cl. 345/531

(57) ABSTRACT

A method and apparatus for a logo display of a multimedia player are provided. The apparatus includes a memory which stores at least one logo to be displayed on the multimedia player, a logo location pointer which points to the location of the memory at which a logo to be displayed on the multimedia player is stored, a display unit which displays a logo, and a controller which reads a logo from the memory based on the logo location pointer and outputs that logo to the display unit, if a log display of the multimedia player is requested, wherein the logo location pointer points to the location of the memory at which a logo based on the media title is stored if a media title is inserted in the multimedia player.

### CROSS-REFERENCE TO RELATED PATENT APPLICATION

This application claims priority from Korean Patent Application No. 10-2006-0124046, filed on Dec. 7, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to a logo display of a multimedia player.

2. Description of the Related Art

Multimedia players are devices for reproducing data recorded on media such as Compact Discs (CDs), Digital Versatile Discs (DVDs), High Definition DVDs (HD-DVDs), Blueray Discs (BDs), and the like. Some multimedia players have a function for displaying pre-stored logos when they are powered on. For example, a Blueray player produced by Samsung Electronics displays a Samsung logo and a Blueray logo, even though users know that the Blueray player is made by Samsung Electronics and can play BDs.

However, logos displayed on existing multimedia players are not concerned with media titles. Thus, no existing multimedia player has logos for providing users with information on media titles, such as whether a media title is inserted, what media title is inserted, whether the inserted media title has been previously played and interrupted, and in that case the time at which playback was interrupted.

A media title is a media product produced using an arbitrary medium. For example, if a movie or game is marketed on a DVD, the DVD is called a DVD title, if on a CD, the CD is called a CD title, if on a HD-DVD, the HD-DVD is called a HD-DVD title, and if on a BD, the BD is called a BD title. However, even if a user duplicates a movie or game using a DVD without permission, the DVD is not called a DVD title.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a logo display method and apparatus of a multimedia player, by which a user can easily obtain information regarding a media title based on a logo displayed on the multimedia player.

According to an aspect of the present invention, there is provided a logo display method of a multimedia player, the method comprising: checking a logo location pointer if a logo display of the multimedia player is requested; and reading a logo from a memory included in the multimedia player based on the logo location pointer and displaying the logo, wherein if a media title is inserted in the multimedia player, the logo location pointer points to the location at which a logo based on the media title is stored, and if no media title is inserted in the multimedia player, the logo location pointer points to the location at which a logo set as default in the multimedia player is stored.

The method may further comprise: if a media title is inserted into the multimedia player, creating a logo of the media title based on information detected from the media title; storing the created logo; and updating the logo location pointer to point to the location at which the created logo is stored.

The method may further comprise: if the media title is reproduced, recreating a logo of the media title according to a reproduction time point; and updating the logo of the media title to the recreated logo.

The method may further comprise: if the media title is ejected from the multimedia player, deleting a logo based on the media title, which is stored in the memory; and updating the logo location pointer to point to the location at which the logo set as default in the multimedia player is stored.

According to another aspect of the present invention, there is provided a logo display apparatus of a multimedia player, the apparatus comprising: a memory which stores at least one logo to be displayed on the multimedia player; a logo location pointer which has information on a location of the memory at which a logo to be displayed on the multimedia player is stored; a display unit which displays a logo; and a controller which reads a logo from the memory based on the logo location pointer and outputs the read logo to the display unit if a log display of the multimedia player is requested, wherein if a media title is inserted in the multimedia player, the logo location pointer points to the location of the memory at which a logo based on the media title is stored, and if no media title is inserted in the multimedia player, the logo location pointer points to the location of the memory at which a logo set as default in the multimedia player is stored.

The apparatus may her comprise: a media title insert/eject determiner which determines whether a media title is inserted into or ejected from the multimedia player; and a logo creator which creates a logo of the media title based on information detected from the media title under the control of the controller, and stores the created logo in the memory if it is determined by the media title insert/eject determiner that the media title is inserted into the multimedia player, wherein if the created logo of the media title is stored in the memory, the controller updates the logo location pointer to point to the location of the memory at which the created logo of the media title is stored.

The apparatus may further comprise a reproduction processing unit which reproduces data from the media title, wherein the controller controls the logo creator to recreate a logo of the media title according to a reproduction time point of the media title and store the recreated logo in the memory,

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a logo display apparatus of a multimedia

FIG. 2 is a block diagram of a logo display apparatus of a multimedia player according to another exemplary embodiment of the present invention;

FIG. 3 is a diagram for describing information detected from a media title when the logo display apparatus illustrated in FIG. 2 creates a logo;

FIG. 4 is a block diagram of a logo display apparatus of a multimedia player according to another exemplary embodiment of the present invention;

FIG. 5 is a diagram for describing information detected from a media title when the logo display apparatus illustrated in FIG. 4 creates a logo;

FIG. 6 illustrates a modified example of a memory structure illustrated in FIGS. 2 and 4;

FIG. 7 is a block diagram of a logo creator illustrated in FIG. 2 or 4, which creates a logo containing text information, according to an exemplary embodiment of the present invention;

FIG. 8 is a flowchart illustrating a logo display method of a multimedia player according to an exemplary embodiment of the present invention;

FIG. 9 is a flowchart illustrating a process of creating and storing a logo based on a media title in a logo display method of a multimedia player according to an exemplary embodiment of the present invention;

FIG. 10 is a flowchart illustrating a process of creating and storing a logo based on a media title while reproducing the media title, in a logo display method of a multimedia player according to an exemplary embodiment of the

FIG. 11 is a flowchart illustrating a logo process based on a media title when the media title is ejected, in a logo display method of a multimedia player according to an exemplary embodiment of the present invention.

### DETAILED DESCRIPTION OF THE INVENTION

The present invention will now be described in detail by explaining exemplary embodiments of the invention with reference to the attached drawings.

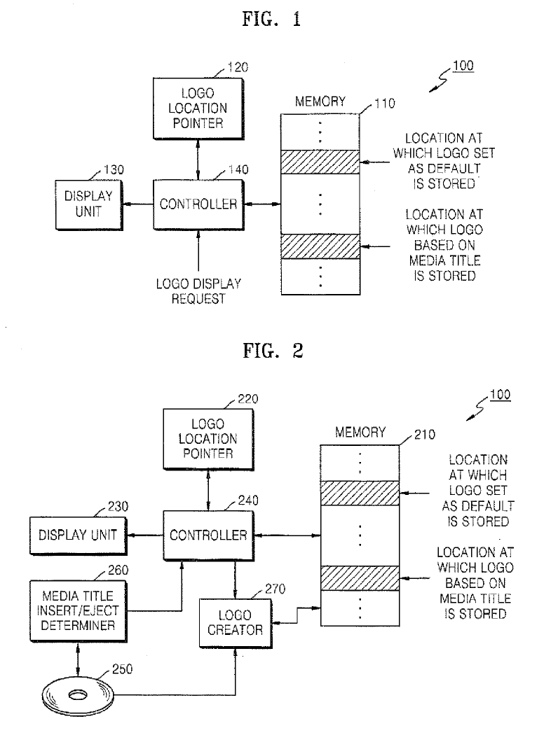

FIG. 1 is a block diagram of a logo display apparatus 100 of a multimedia player according to an exemplary embodiment of the present invention. Referring to FIG. 1, the logo display apparatus 100 includes a memory 110, a logo location pointer 120, a display unit 130, and a controller 140.

The memory 110 stores at least one logo to be displayed on the multimedia player, including at least a logo set as default in the multimedia player and a logo based on a media title inserted into the multimedia player. As illustrated in FIG. 1, the logo set as default is stored at a different location in the memory 110 from the logo based on the media title.

The logo location pointer 120 contains information on the location of the memory 110 at which a logo to be displayed on the multimedia player is stored. If no media title is inserted into the multimedia player, the controller 140 sets the logo location pointer 120 to the location of the memory 110 at which the logo set as default is stored. If a media title is inserted into the multimedia player, the controller 140 sets the logo location pointer 120 to the location of the memory 110 at which the logo based on the media title inserted into the multimedia player.

The display unit 130 displays a logo stored in the memory 110 under the control of the controller 140.

If the multimedia player is requested to display a logo, the controller 140 checks the logo location pointer 120. If the multimedia player is turned on or booted, the controller 140 can detect that the logo display has been requested. The controller 140 reads a logo from the memory 110 based on location information stored in the logo location pointer 120. That is, if the location information stored in the logo location pointer 120 is the location at which the logo set as default is stored, the controller 140 reads the logo set as default from the memory 110. If the location information stored in the logo location pointer 120 is the location at which the logo based on the media title is stored, the controller 140 reads the logo based on the media title from the memory 110. The controller 140 outputs the logo read from the memory 110 through the display unit 130.

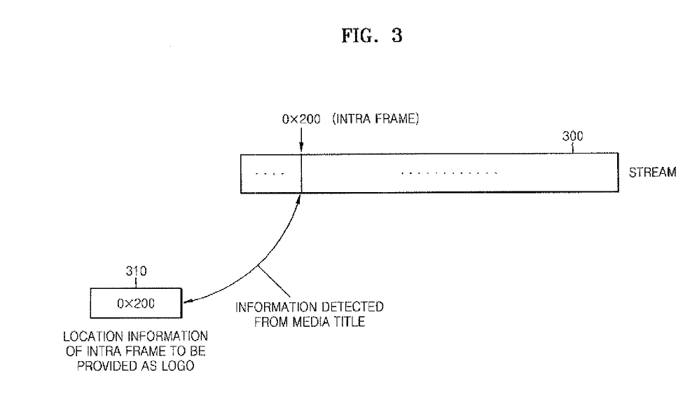

FIG. 2 is a block diagram of a logo display apparatus 200 of a multimedia player according to another exemplary embodiment of the present invention. Referring to FIG. 2, the logo display apparatus 200 includes a memory 210, a logo location pointer 220, a display unit 230, a controller 240, a media title 250, a media title insert/eject determiner 260, and a logo creator 270.

The memory 210, the logo location pointer 220, and the display unit 230 illustrated in FIG. 2 are configured and operate similarly to the memory 110, the logo location pointer 120, and the display unit 130 illustrated in FIG. 1.

The media title 250 is a media product produced using an arbitrary medium If the media title 250 is produced on a DVD, the media title 250 can be called a DVD title. If on a CD, the media title 250 can be called a CD title. If on a HD-DVD, the media title 250 can be called a HD-DVD title. If on a BD, the media title 250 can be called a BD title.

The media title insert/eject determiner 260 determines whether the media title 250 is inserted into or ejected from the multimedia player. The media title insert/eject determiner 260 can be associated with a tray (not shown) on which the media title 250 sits and a loading motor (not shown), as in an existing optical disk drive. For example, the media title insert/eject determiner 260 can include a sensor (not shown) for sensing whether the media title 250 sits in the tray. The media title insert/eject determiner 260 outputs a determination result to the controller 240.

If it is determined by the media title insert/eject determiner 260 that the media title 250 has been inserted into the multimedia player, the controller 240 enables the logo creator 270 to operate. Then, the logo creator 270 creates a logo of the media title 250 based on information detected from the media title 250, and stores the logo in the memory 210. The information detected from the media title 250 includes navigation information of the media title 250 and an intra frame read from the media title 250 based on the navigation information.

The navigation information includes information on at least one location at which the intra frame to be used in logo creation is stored in the media title 250. The intra frame and its location in the media title 250 are determined by the manufacturer of the media title 250.

For example, if the navigation information includes location information 310 of a single intra frame illustrated in FIG. 3, the logo creator 270 reads the intra frame located at ‘0x200’ from the media title 250 by referring to the intra frame location information 310. FIG. 3 is a diagram for describing information detected from the media title 250 when the logo display apparatus 200 illustrated in FIG. 2 creates a logo. In FIG. 3, reference numeral 300 denotes the structure of a data stream stored in the media title 250. The logo creator 270 creates a logo based on the media title 250 using the intra frame, and stores the logo in the memory 210.

When the logo created by the logo creator 270 is stored in the memory 210, the controller 240 updates the logo location pointer 220 to point to the location of the memory 210 at which the logo of the media title 250 is stored.

If it is determined by the media title insert/eject determiner 260 that the media title 250 has been ejected from the multimedia player, the controller 240 deletes the logo based on the media title 250, which is stored in the memory 210, and updates the logo location pointer 220 to point to the location of the memory 210 at which the logo set as default is stored.

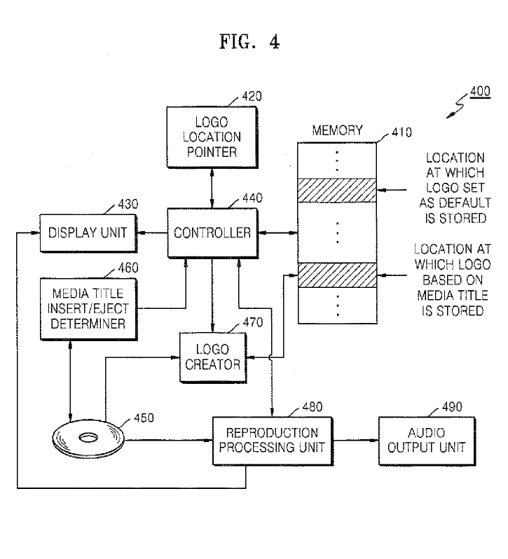

FIG. 4 is a block diagram of a logo display apparatus 400 of a multimedia player according to another exemplary embodiment of the present invention. Referring to FIG. 4, the logo display apparatus 400 includes a memory 410, a logo location pointer 420, a display unit 430, a controller 440, a media title 450, a media title insert/eject determiner 460, a logo creator 470, a reproduction processing unit 480, and an audio output unit 490.

The memory 410, the logo location pointer 420, the display unit 430, the media title 450, and the media title insert/eject determiner 460 illustrated in FIG. 4 are configured and operate similarly to the memory 210, the logo location pointer 220, the display unit 230, the media title 250, and the media title insert/eject determiner 260 illustrated in FIG. 2.

In the case of FIG. 4, navigation information detected from the media title 450 can include location information of a single intra frame in the media title 450 to be used in logo creation, as defined in FIG. 2. However, the navigation information can be implemented to include location information of a plurality of intra frames. If a plurality of intra frames are included in the navigation information, the location information of the plurality of intra

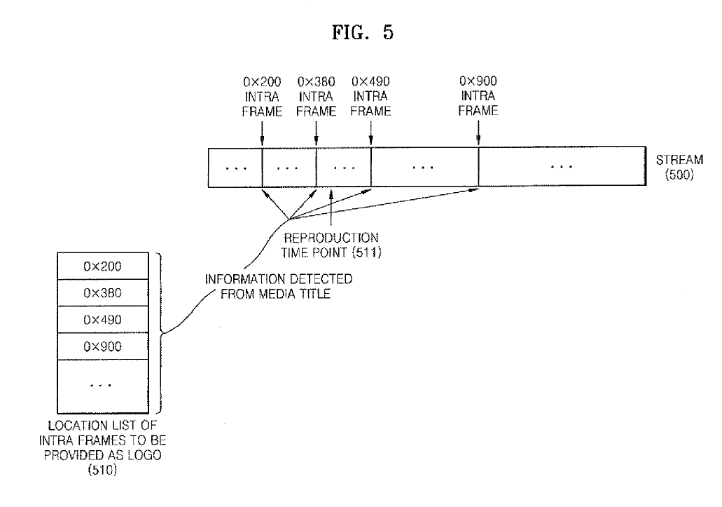

FIG. 5 is a diagram for describing information detected from the media title 450 when the logo display apparatus 400 illustrated in FIG. 4 creates a logo. Referring to FIG. 5, if the navigation information includes a location list 510 of intra frames to be provided as logos, the logo creator 470 can create a logo of the media title 450 according to a reproduction time point, and store the logo in the memory 410.

That is, if a time point where the reproduction processing unit 480 reproduces data read from the media title 450 corresponds to a point referred to by reference numeral 511, the logo creator 470 reads an intra frame from the media title 450 based on location information ‘0x380’ of a previously reproduced intra frame closest to the reproduction time point 511 by referring to the intra frame location list 510, and recreates that intra frame as a logo of the media title 450.

The recreation operation of the logo creator 470 is controlled by the controller 440. That is, the controller 440 detects a reproduction time point by monitoring the reproduction processing unit 480, and provides information on that reproduction time point to the logo creator 470. Then, the logo creator 470 recreates a logo based on location information of a previously reproduced intra frame closest to the detected reproduction time point.

The logo creator 470 continues to perform the logo recreation of the media title 450 based on the intra frame location list 510. For example, if the navigation information includes the intra frame location list 510 and the media title 450 is inserted into the multimedia player, the logo creator 470 first creates a logo of the media title 450 by reading an intra frame from the media title 450 based on location information ‘0x200’, and stores that logo in a logo storage location of the memory 410 based on the media title 450.

Thereafter, if a reproduction mode of the media title 450 is set and the reproduction processing unit 480 reproduces data read from the media title 450, the logo creator 470 recreates a logo of the media title 450 according to a reproduction time point monitored by the controller 440. That is, the logo creator 470 does not recreate the logo of the media title 450 until playback of the media title 450 reaches an intra frame location ‘0x380’. However, once playback passes the intra frame location ‘0x380’, the logo creator 470 recreates a logo of the media title 450 using the intra frame located at ‘0x380’ and updates the logo stored in the memory 410 based on the media title 450 to the recreated logo.

Thereafter, once playback passes the intra frame location ‘0x490’, the logo creator 470 recreates a logo of the media title 450 using the intra frame located at ‘0x490’ and updates the logo stored in the memory 410 based on the media title 450 to the recreated logo.

Once playback passes the intra frame location ‘0x900’, the logo creator 470 recreates a logo of the media title 450 using the intra frame located at ‘0x900’ and updates the logo stored in the memory 410 based on the media title 450 to the recreated logo.

The logo recreation process is performed based on the intra frame location list 510 until the media title 450 has been completely reproduced If the intra frame location list 510 contains only the four pieces of intra frame location information ‘0x200’, ‘0x380’, ‘0x490’, and ‘0x900’, the logo creator 470 recreates the logo three times during playback.

However, if the navigation information does not include an intra frame location list like that referred to as 510, the logo creator 470 can be implemented to recreate a logo of the media title 450 using an intra frame obtained from the media title 450 based on location information of a previously reproduced intra frame closest to a reproduction time point In this case, if the media title 450 is inserted into the multimedia player, the logo creator 470 creates a logo of the media title 450 by reading an initial intra frame and thereafter recreates the logo of the media title 450 by reading an intra frame from the media title 450 every time playback passes an intra frame stored in the media title 450. In this case, the intra frame read from the media title 450 to create a logo is the most recently reproduced intra frame.

The display unit 430 displays not only a logo of the media title 450 according to an exemplary embodiment of the present invention but also an image reproduced by the reproduction processing unit 480. If the reproduction of the media title 450 is stopped, the display unit 430 displays a logo based on the media title 450, which is stored in the memory 410. The displayed logo is recreated according to a reproduction time point.

The audio output unit 490 outputs an audio signal reproduced by the reproduction processing unit 480.

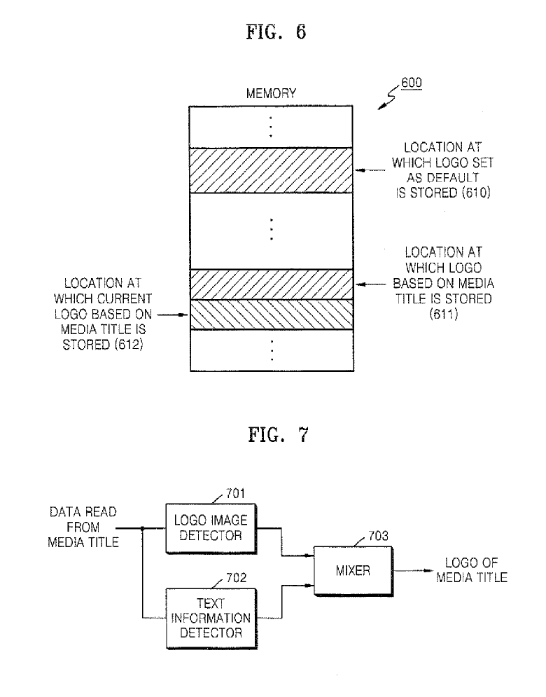

The memories 210 and 410 illustrated in FIGS. 2 and 4 have only one storage location for logos based on a media title. However, for double buffering, the memories 210 and 410 illustrated in FIGS. 2 and 4 can be used so that a recreated logo can be stored at a different location to the previously created logo. For example, as illustrated in FIG. 6, the memories 210 and 410 illustrated in FIGS. 2 and 4 can have two storage locations for logos based on a media title.

FIG. 6 illustrates a modified example of the memory structure illustrated in FIGS. 2 and 4. In FIG. 6, a storage location referred to by reference numeral 611 is used to store the previous logo of a media title, and a storage location referred to by reference numeral 612 is used to store the current logo of the media title. For example, when the logo creator 470 creates a current logo based on ‘0x490’ of the intra frame location list 510, a logo based on the intra frame located at ‘0x490’ is stored at the storage location 612, and a logo based on the intra frame located at ‘0x380’ is stored at the storage location 611.

However, if the logo of the media title 450 is recreated, the storage location 611 is used to store the new current logo of the media title 450, and the storage location 612 is used to store the previous logo of the media title 450. As described above, when two storage locations are used, every time a logo of the media title 450 is recreated, the controller 440 updates the logo location pointer 420. Referring to FIG. 6, the controller 440 controls the logo location pointer 420 to point alternately to the storage location 611 and the storage location 612 every time a logo of the media title 450 is recreated. However, if the multimedia player is turned off before the current logo has been completely stored, or if the logo creator 470 fails to create (or recreate) the current logo, the controller 440 does not update the logo location pointer 420.

The navigation information described in FIGS. 2 and 4 can further include text information of the media title 250 or 450. The text information can be, for example, the title of content stored in the media title 250 or 450. In this case, the logo creator 270 or 470 can be implemented to create a logo including the text information for the media title 250 or 450.

FIG. 7 is a block diagrams of the logo creator 270 or 470 illustrated in FIG. 2 or 4, which creates a logo containing text information, according to an exemplary embodiment of the present invention. Referring to FIG. 7, the logo creator 270 or 470 includes a logo image detector 701, a text information detector 702, and a mixer 703.

The logo image detector 701 detects an intra frame read from the media title 250 or 450 as a logo image as described in FIG. 2 or 4. The text information detector 702 detects text information included in the navigation information read from the media title 250 or 450. The mixer 703 outputs an image obtained by mixing the logo image detected by the logo image detector 701 and the text information detected by the text information detector 702, as a logo of the media title 250 or 450. The mixer 703 can mix the text information with the logo image in the form of subtitle information.

The logo creator 270 or 470 illustrated in FIG. 2 or 4 can be implemented to create a media title logo including the logo set as default by further using the logo set as default in the multimedia player. To do this, the text information detector 702 can be modified to be a default logo reader reading the logo set as default, which is stored in the memory 210 or 410. In this case, the mixer 703 can output an image obtained by mixing the logo image based on the media title 250 or 450 and the default logo image as a logo of the media title 250 or 450. In this case, the mixer 703 can mix the logo image based on the media title 250 or 450 and the default logo image in the form of Picture In Picture (PIP).

the logo creator 270 or 470 illustrated in FIG. 2 or 4 can be implemented to create an image by mixing the logo image based on the media title 250 or 450, the text information of the media title 250 or 450, and the default logo image, as a logo of the media title 250 or 450. The logo creator 270 or 470 illustrated in FIG. 2 or 4 can be implemented to selectively create one of the above-described various forms of logos of the media title 250 or 450, under the control of the controller 240 or 440. The above-described various forms of logos of the media title 250 or 450 include a logo based on an infra frame read from the media title 250 or 450, a logo obtained by mixing an infra frame read from the media title 250 or 450 and text information, a logo obtained by mixing an infra frame read from the media title 250 or 450 and the default logo, and a logo obtained by mixing an infra frame read from the media title 250 or 450, the text information, and the default logo.

If the media title 250 or 450 is ejected from the multimedia player, the controller 240 or 440 illustrated in FIG. 2 or 4 deletes the media title logo stored in the memory 210 or 410 and updates the logo location pointer 220 or 420 to point to the location at which the logo set as default in the multimedia player is stored. If the memory 210 or 410 has two storage locations as described in FIG. 6, the controller 240 or 440 deletes both logos of the media title 250 or 450 stored at the two storage locations.

The logo display apparatus 100, 200, or 400 illustrated in FIG. 1, 2, or 4 is included in a multimedia player. The multimedia player is a device can play a medium such as a CD, a DVD, a HD-DVD, or a BD.

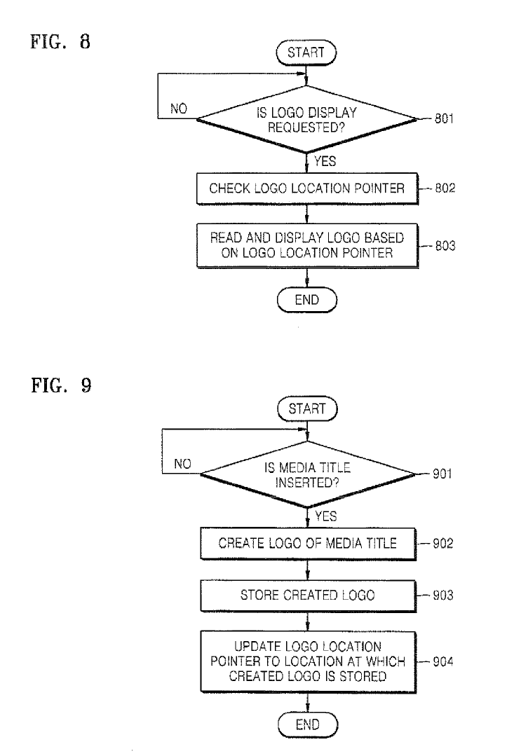

FIG. 8 is a flowchart illustrating a logo display method of a multimedia player according to an exemplary embodiment of the present invention. The process of FIG. 8 will now be described with reference to FIG. 1.

When a logo display of the multimedia player is requested in operation 801, the controller 104 checks the logo location pointer 120 in operation 802. If a media title is inserted in the multimedia player, the logo location pointer 120 has information on the location at which a logo based on the media title is stored. If no media title is inserted in the multimedia player, the logo location pointer 120 has information on the location at which a logo set as default in the multimedia player is stored.

In operation 803, the controller 140 reads the logo from the memory 110 included in the multimedia player based on the logo location pointer 120, and displays the logo. Thus, if the media title is inserted in the multimedia player, the logo based on the media title is displayed on the display unit 130. If no media title is inserted in the multimedia player, the logo set as default is displayed on the display unit 130.

FIG. 9 is a flowchart illustrating a process of creating and storing a logo based on a media title, in a logo display method of a multimedia player according to an exemplary embodiment of the present invention. The process of FIG. 9 will now be described with reference to FIG. 2.

If it is determined in operation 901 that a media title 250 is inserted in the multimedia player, the controller 240 creates a logo of the media title 250 based on information detected from the media title 250 in operation 902. The information detected from the media title 250 includes the navigation information of the media title 250 and an intra frame read from the media title 250 based on the navigation information. The navigation information includes information on the location at which at least one intra frame to be used in logo creation is stored in the media title 250. The navigation information can further include text information of the media title 250, navigation information further includes text information of the media title 250, the logo creator 270 can create a logo including the text information for the media title 250.

The logo of the media title 250 can be implemented in various forms, e.g., a media title logo containing a logo set as default in the multimedia player, as described in the logo display apparatus according to an exemplary embodiment of the present invention.

The logo created by the logo creator 270 is stored in the memory 120 in operation 903. In operation 904, the controller 240 updates the logo location pointer 220 to point to the location at which the logo is stored.

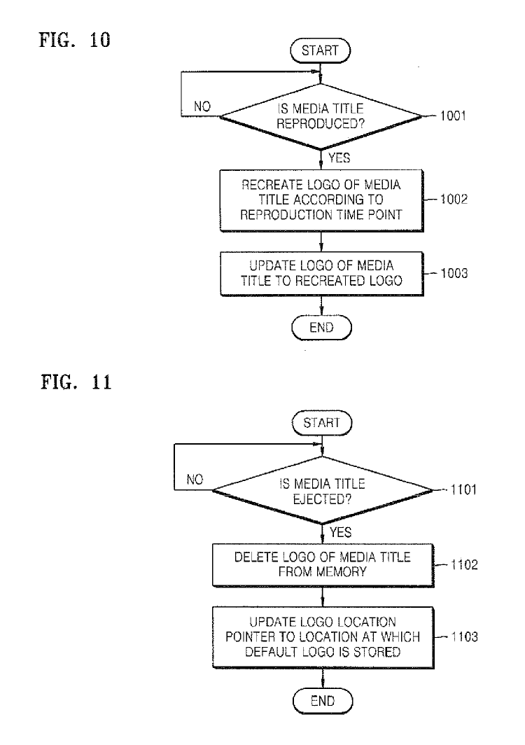

FIG. 10 is a flowchart illustrating a process of creating and storing a logo based on a media title while reproducing the media title, in a logo display method of a multimedia player according to an exemplary embodiment of the present invention. The process of FIG. 10 will now be described with reference to FIG. 4.

If the media title 450 is reproduced, in operation 1001, the controller 440 recreates a logo of the media title 450 based on the navigation information of the media title 450 according to a reproduction time point in operation 1002. The process of recreating a logo of the media title 450 is the same as described for the logo creator 470 illustrated in FIG. 4. That is, the logo creator 470 recreates a logo of the media title 450 using an intra frame read from the media title 450 based on location information of a previously reproduced intra frame closest to the reproduction time point.

The controller 440 updates a logo of the media title 450, which is stored in the memory 410, to the logo recreated by the logo creator 470, in operation 1003. In this case, if the memory 410 has the structure illustrated in FIG. 6, in which a recreated logo is stored at a different location to the previously created logo, the controller 440 updates information on the logo location pointer 420 every time a logo of the media title 450 is recreated. If the multimedia player is turned off while a recreated logo is in the process of being stored, or if the logo recreation fails, the controller 440 does not update the information on the logo location pointer 420, so that the previously created logo remains the media title logo.

FIG. 11 is a flowchart illustrating a logo process based on a media title when the media title is ejected, in a logo display method of a multimedia player according to the exemplary embodiment of the present invention. The process of FIG. 11 will now be described with reference to FIG. 4.

If the media title 450 is ejected from the multimedia player in operation 1101, the controller 440 deletes the logo of the media title 450, which is stored in the memory 410, in operation 1102. In operation 1103, the controller 440 updates the logo location pointer 420 to point to the location of the memory 410 at which the logo set as default in the multimedia player is stored.

The invention can also be exemplarily embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, according to the present invention, by displaying information regarding a media title using a logo of a multimedia player, a user can easily obtain the information regarding the media title, such as whether a media title is inserted in the multimedia player, what media title is inserted, or where playback was last interrupted, based on the logo displayed on the multimedia player.

In addition, a displayed logo can be updated according to a media title inserted into a multimedia player or a point at which playback was interrupted, and the user can be provided with various information by mixing a logo based on the media title and a logo set as default in a multimedia player, or mixing text information of a media title and image information of the media title.

Since the media title producer can define the content to be displayed as a logo, media titles can be used for advertising.

While this invention has been particularly shown and described with reference to exemplary embodiments thereof, it will be understood by those skilled in the art that various changes in form and detail may be made therein without departing from the spirit and scope of the invention as defined by the appended claims. The exemplary embodiments should be considered in a descriptive sense only, and not for purposes of limitation. Therefore, the scope of the invention is defined not by the detailed description of the invention but by the appended claims, and all differences within the scope will be construed as being included in the present invention.

What is claimed is:

1. A logo display method of a multimedia player, the method comprising:
checking a logo location pointer if a logo display of the multimedia player is requested; and
reading a logo from a memory included in the multimedia player based on the logo location pointer, and
displaying the logo,
wherein the logo location pointer has information on a location at which a logo based on the media title is stored if a media title is inserted in the multimedia player.

2. The method of claim 1, further comprising:
creating a logo of the media title based on information detected from the media title if a media title is inserted into the multimedia player;
storing the created logo; and
updating the logo location pointer to point to the location at which the created logo is stored.

3. The method of claim 2, wherein the information detected from the media title comprises navigation information of the media title and an intra frame read from the media title based on the navigation information.

4. The method of claim 3, wherein the navigation information comprises information on a location at which at least one intra frame to be used in the creation of a logo based on the media title is stored in the media title.

5. The method of claim 1, further comprising:
recreating a logo of the media title according to a reproduction time point if the media title is reproduced; and
updating the logo of the media title to the recreated logo.

6. The method of claim 5, wherein the recreating of the logo the media title based on location information of a previously reproduced intra frame closest to the reproduction time point.

7. The method of claim 5, wherein the updating of the logo of the media title comprises:
storing the recreated logo at a different location to a previously reproduced logo; and
maintaining the previously created logo as the logo of the media title if the multimedia player is turned off before the recreated logo has been completely stored or if the logo recreation fails.

8. The method of claim 3, wherein the navigation information further comprises text information of the media title, and a logo containing the text information is created as the logo of the media title.

9. The method of claim 1, further comprising:
deleting a logo based on the media title from the memory if the media title is ejected from the multimedia player; and
updating the logo location pointer to point to the location at which a logo set as default in the multimedia player is stored.

10. The method of claim 2, wherein the creating of the logo of the media title comprises creating the media title logo containing a logo which is set as default in the multimedia player by further using the logo set as default in the multimedia player.

11. The method of claim 1, wherein the logo location pointer points to the location at which the logo set as default in the multimedia player is stored if no media title is inserted in the multimedia player.

12. A logo display apparatus of a multimedia player, the apparatus comprising:
a memory which stores at least one logo to be displayed on the multimedia player;
a logo location pointer which has information on the location in the memory where a logo to be displayed on the multimedia player is stored;
a display unit which displays a logo; and
a controller which reads a logo from the memory based on the logo location pointer and outputs the read logo to the display unit if a logo display of the multimedia player is requested,
wherein the logo location pointer points to the location of the memory at which a logo based on the media title is stored if a media title is inserted in the multimedia player.

13. The apparatus of claim 12, further comprising:
a media title insert/eject determiner which determines whether a media title is inserted into or ejected from the multimedia player; and
a logo creator which creates a logo of the media title based on information detected from the media title by the controller, and stores the created logo in the memory if it is determined by the media title insert/eject determiner that the media title is inserted into the multimedia player,
wherein the controller updates the logo location pointer to point to the location of the memory at which the created logo of the media title is stored if the created logo of the media title is stored in the memory.

14. The apparatus of claim 13, wherein the information detected from the media title comprises navigation information of the media title and an intra frame read from the media title based on the navigation information.

15. The apparatus of claim 14, wherein the navigation information comprises information on a location at which at least one intra frame to be used in the creation of a logo based on the media title is stored in the media title.

16. The apparatus of claim 14, further comprising a reproduction processing unit which reproduces data from the media title,
wherein the controller controls the logo creator to recreate a logo of the media title according to a reproduction time point of the media title, and store the recreated logo in the memory.

17. The apparatus of claim 16, wherein the logo creator recreates the logo of the media title using an intra frame read from the media title based on location information of a previously reproduced intra frame closest to the reproduction time point.

18. The apparatus of claim 16, wherein when the logo recreated by the logo creator is stored at a different location to a previously reproduced logo, the controller does not update the logo location pointer if the multimedia player is turned off before the recreated logo has been completely stored, or if the logo creator fails to recreate the logo.

19. The apparatus of claim 14, wherein the navigation information further comprises text information of the media title, and
the logo creator creates a logo containing the text information as the logo of the media title.

20. The apparatus of claim 12, wherein the controller deletes a logo based on the media title, which is stored in the memory, and updates the logo location pointer to point to the location at which a logo set as default in the multimedia player is stored if the media title is ejected from the multimedia player.

21. The apparatus of claim 13, wherein the logo creator creates the media title logo containing a logo set as default in the multimedia player by further using the logo set as default in the multimedia player.

22. The apparatus of claim 12, wherein the logo location pointer points to the location of the memory at which a logo set as default in the multimedia player is stored if no media title is inserted in the multimedia player.
